(19) United States
(12) Patent Application Publication
(10) Pub. No.: US 2014/0372493 A1
(43) Pub. Date: Dec. 18, 2014

(54) SYSTEM AND METHOD FOR ACCELERATING EVALUATION OF FUNCTIONS

(71) Applicants: Texas Instruments Incorporated, Dallas, TX (US); Texas Instruments Deutschland GmbH, Freising (DE)

(72) Inventors: Brent Everett Peterson, Westwood, MA (US); Nitya Ramdas, Richardson, TX (US); Sotirios Christodulos Tsongas, Frisco, TX (US); Jonathan Zack Albus, Sachse, TX (US); Johann Zipperer, Unterschleissheim (DE)

(21) Appl. No.: 13/918,209

(22) Filed: Jun. 14, 2013

(51) Int. Cl. G06F 7/483

(52) U.S. Cl. CPC G06F 7/483
USPC 708/209; 708/495; 708/500; 708/503

(57) ABSTRACT

A system and method for accelerating evaluation of functions. In one embodiment, a method includes receiving, by a processor, a value to be processed, and notification of a function to be applied to the value. The value is represented in a floating point format. The value is converted, by the processor, to a fixed point format. Which of Newton-Raphson and polynomial approximation is to be used to apply the function to the value in the fixed point format is determined by the processor. The function is applied to the value in the fixed point format to generate a result in the fixed point format. The result is converted to the floating point format by the processor.

### BACKGROUND

Many computer applications require the evaluation of mathematical functions, such as trigonometric functions, exponential functions, root functions, etc. Evaluation of such mathematical functions is typically provided by a library of software routines executed by a processor.

### SUMMARY

A system and method for accelerating evaluation of functions are disclosed herein. In one embodiment, a method includes receiving, by a processor, a value to be processed, and notification of a function to be applied to the value. The value is represented in a floating point format. The value is converted, by the processor, to a fixed point format. Which of Newton-Raphson and polynomial approximation is to be used to apply the function to the value in the fixed point format is determined by the processor. The function is applied to the value in the fixed point format to generate a result in the fixed point format. The result is converted to the floating point format by the processor.

In another embodiment, .a computer-readable medium is encoded with instructions that when executed cause a processor to: 1) receive a value to be processed, the value in a floating point format; 2) receive notification of a function to be applied to the value; 3) convert the value to a fixed point format; 4) determine which of Newton-Raphson and polynomial approximation is to be used to apply the function to the value in the fixed point format; 5) apply the function to the value in the fixed point format to generate a result in the fixed point format; and 6) convert the result to the floating point format.

In a further embodiment, a system includes a processor and mathematical processing logic. The processor includes a multiplier that is selectably configurable to operate in a fractional mode. When executed, the mathematical processing logic causes the processor to: 1) receive a floating point value to be processed; 2) receive notification of a function to be applied to the floating point value; 3) convert the floating point value to a fixed point value; 4) determine which of Newton-Raphson and polynomial approximation is to be used to apply the function to the fixed point value; 5) apply the function to the fixed point value to generate a fixed point result; and 6) convert the fixed point result to a floating point result.

### BRIEF DESCRIPTION OF THE DRAWINGS

For a detailed description of various examples, reference will now be made to the accompanying drawings in which:

FIG. 1 shows a block diagram for a system for evaluating a function in accordance with various embodiments;

FIG. 2 shows a flow diagram for a method for evaluating a function in accordance with various embodiments;

FIG. 3 shows a flow diagram for a method for converting a floating point operand to a fixed point operand in accordance with various embodiments;

FIG. 4 shows a flow diagram for a method for reducing the range of a fixed point operand in accordance with various embodiments;

FIG. 5 shows a flow diagram for a method for evaluating a polynomial in accordance with various embodiments;

FIG. 6 shows a flow diagram for a method for evaluating a polynomial using a polynomial accelerator in accordance with various embodiments;

FIG. 7 shows a flow diagram for a method for evaluating a function using Newton-Raphson approximation in accordance with various embodiments;

FIG. 8 shows a flow diagram for a method for multiplying operands using a multiplier having a fractional mode in accordance with various embodiments;

FIG. 9 shows a flow diagram for a method for multiplying operands using a multiplier having lacking a fractional mode in accordance with various embodiments; and

FIG. 10 shows a flow diagram for a method for converting a fixed point result of function evaluation to a floating point format in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

Also, the term “couple” or “couples” is intended to mean either an indirect or direct electrical connection. Thus, if a first device couples to a second device, that connection may be through a direct electrical connection, or through an indirect electrical connection via other devices and connections.

The recitation “based on” is intended to mean “based at least in part on.” Therefore, if X is based on Y, X may be based on Y and any number of other factors.

A “fixed point format,” “fixed point representation,” and the like refers to a form of representation of numbers in a computer wherein the position of the point separating the whole part of the number from the fractional part of the number is constant.

A “floating point format,” “floating point representation,” and the like refers to a form of representation of numbers in a computer wherein the position of the point separating the whole part of the number from the fractional part of the number is variable.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In order to provide adequate precision and range, operands and results of mathematical functions may be provided in a floating point format. Accordingly, routines that evaluate the functions manipulate the operands via floating point operations, such floating point multiplication, floating point addition, etc. Unfortunately, the computational overhead of floating point arithmetic can be high. To reduce the overhead associated with floating point computation, some conventional systems include a hardware floating point acceleration unit. However, floating point hardware can be expensive, and is consequently lacking in the vast majority of processors and processor-based systems.

Embodiments of the present disclosure include novel computational techniques that greatly reduce function evaluation time without loss of accuracy. Some embodiments provide greater than 9× performance improvement relative to conventional floating point math libraries while providing equivalent computational accuracy. For example, evaluation of a trigonometric function in accordance with principals disclosed herein may require fewer than 500 processor cycles, while a conventional floating point math library may require nearly 5000 processor cycles to produce an equivalent result.

Embodiments do not employ hardware floating point acceleration, thereby reducing hardware costs. At least some embodiments include a fractional multiplier and/or polynomial accelerator to facilitate function evaluation using fixed point operands. Examples of functions evaluated by various embodiments include sine, cosine, tangent, arcsine, arccosine, arctangent, and two argument arctangent, exponential, logarithm, square root, reciprocal, modulus, absolute value, etc.

FIG. 1 shows a block diagram for a system 100 for evaluating a function in accordance with various embodiments. The system 100 includes a processor 102 and storage 1008. The processor 102 may be, for example, a microcontroller or general-purpose microprocessor. In some embodiments, the processor 102 may be a 16-bit microcontroller. The processor 102 includes a multiplier 1004 that may include an operational mode that provides fractional multiplication. In some embodiments, the fractional multiplication mode may be selectable. The processor 102 may also include a polynomial accelerator 104. The polynomial accelerator 104 is a hardware subsystem that efficiently evaluates a polynomial given a variable value, a polynomial order value, and a set of polynomial coefficients. The polynomial accelerator 104 may operate as a coprocessor in the processor 102 in some embodiments. The processor 102 may also include other components, such as an arithmetic logic unit, a shifter, etc. useable in function evaluation. The processor 102 lacks floating point computation hardware.

The processor 102 executes instructions stored in and retrieved from the storage 108. The storage 108 is a computer-readable storage medium that includes volatile storage such as random access memory, non-volatile storage (e.g., a hard drive, an optical storage device (e.g., CD or DVD), FLASH storage, read-only-memory), or combinations thereof. The storage 108 includes a mathematical processing module 110 that includes instructions executable by the processor 102 to perform the operations disclosed herein, including evaluation of functions. The processor 110 may also store function input and/or output values in the storage 108.

Software instructions alone are incapable of performing a function. Therefore, in the present disclosure, any reference to a function performed by software instructions, or to software instructions performing a function is simply a shorthand means for stating that the function is performed via execution of the instructions by the processor 102.

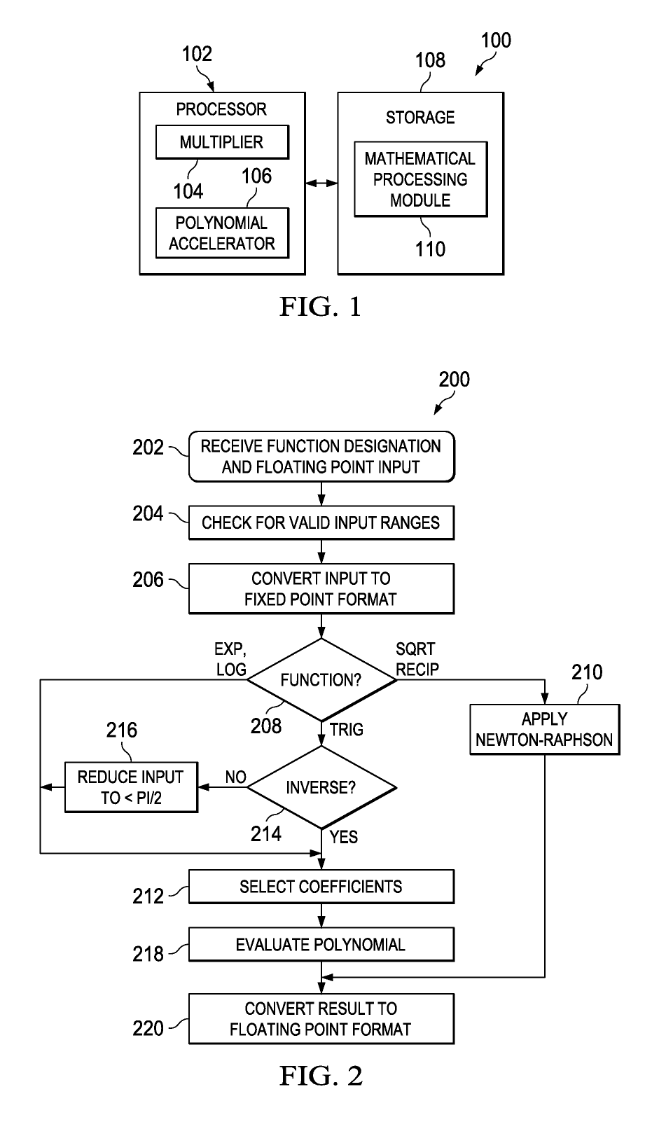

FIG. 2 shows a flow diagram for a method 200 for evaluating a function in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 200, as well as other operations described herein, can be performed by a processor executing instructions stored in a computer readable medium as disclosed herein.

In block 202, the processor 102 is executing instructions of the mathematical processing module 110 and receives designation of a function to be evaluated and a floating point input value to be applied to the function (i.e., a value at which the function is be evaluated). The floating point input value may be, for example, encoded in accordance with the IEEE 754 floating point standard.

In block 204, the processor 102 checks the floating point input value to ensure that the floating point input value falls within a range of values to which function evaluation is restricted. For example, a predetermined minimum and maximum input value may be specified for use with the mathematical processing module 110.

In block 206, the processor 102 converts the floating point input value to a fixed point value.

In block 208, the processor 102 determines which of a plurality of functions that can be evaluated by the mathematical processing module 110 has been designated for evaluation. If the function is a reciprocal determination or root function, then, in block 210, the processor 102 applies Newton-Raphson approximation to evaluate the function. If the function is a trigonometric function, exponential, or logarithm, then the function will be evaluated by polynomial approximation. If the function is an exponential or logarithm, then the processor selects the appropriate coefficients to apply in the polynomial in block 212. For example, the processor 102 may retrieve the coefficients and/or polynomial order information to be applied in each polynomial from a table provided in storage 108.

If the designated function is a trigonometric function, then in block 210, the processor 102 determines whether the function is an inverse trigonometric function. If the function is an inverse trigonometric function, then in block 212, the processor 102 selects the appropriate coefficients to apply in the polynomial.

If the function is a trigonometric function and is not an inverse trigonometric function, then in block 216, the processor 102 ensures that the fixed point value is less than π/2. If the value is not less than π/2, the processor 102 may reduce the value, for example, by subtracting π/2 from the fixed point value until the fixed point value is less than π/2. The processor 102 selects the appropriate coefficients to apply in the polynomial in block 212.

Having selected the coefficients, the processor 102 evaluates the polynomial in block 218.

In block 220, the processor 102 converts the fixed point result of polynomial or Newton-Raphson approximation to the floating point format in which the input value was received (e.g., IEEE 754 format).

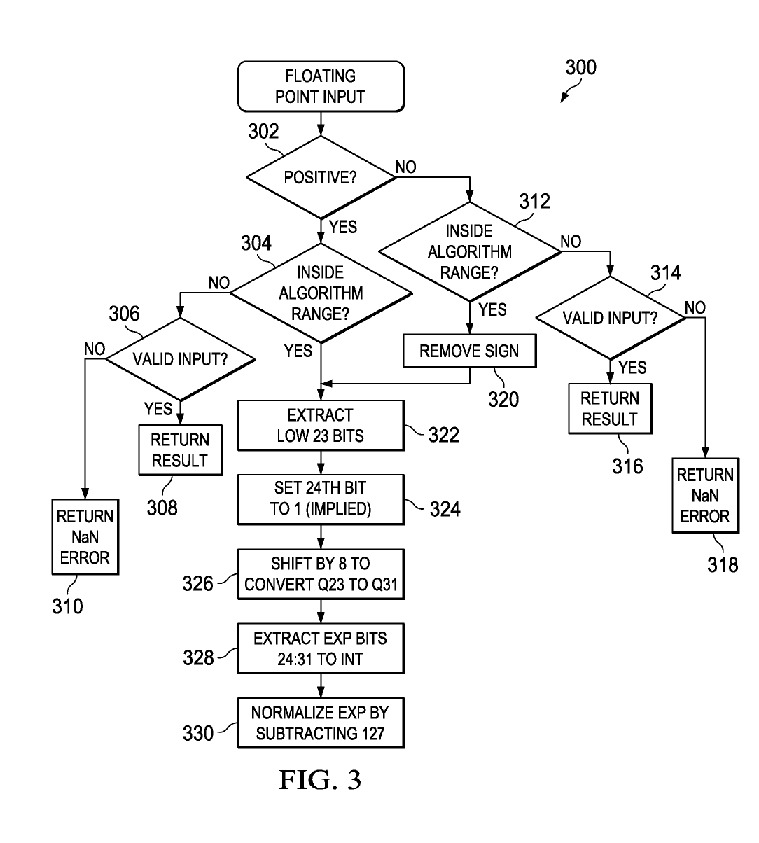

FIG. 3 shows a flow diagram for a method 300 for converting a floating point operand to a fixed point operand in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 300, as well as other operations described herein, can be performed by a processor executing instructions stored in a computer readable medium as disclosed herein. Operations of the method 300 may be performed to effectuate the conversion of block 206 of method 200.

In block 302, the processor 102 determines whether the floating point input value is positive. If the input value is positive, then in block 304, the processor 102 determines whether the input value is within a predetermined range of positive values. The predetermined range of positive values may be, for example, a range of positive values that can be processed by the mathematical processing module 110. If the input value is outside the predetermined range, then, in block 306, the processor 102 determines whether the input value is valid. If the input value is invalid, then in block 310, the processor 102 returns an error value indicating that the input value is not a number. If the input value is valid, then in block 308 the processor 102 returns a default result value.

If the floating point input value is not positive, then in block 312, the processor 102 determines whether the input value is within a predetermined range of negative values. The predetermined range of negative values may be, for example, a range of negative values that can be processed by the mathematical processing module 110. If the input value is outside the predetermined range, then, in block 314, the processor 102 determines whether the input value is valid. If the input value is invalid, then in block 318, the processor 102 returns an error value indicating that the input value is not a number. If the input value is valid, then in block 316 the processor 102 returns a default result value.

If the positive input value is found to be within the predetermined range in block 304, then the processor 102 extracts the mantissa (the lower 23 bits) of the floating point value in block 322. Similarly, if the negative input value is found to be within the predetermined range in block 312, then the processor 102 removes and stores the sign flag of the floating point value in block 320, and extracts the mantissa (the lower 23 bits) of the floating point value in block 322. The sign flag may be stored as an eight bit unsigned integer.

In block 324, the processor 102 sets the bit above the most significant of the 23 extracted mantissa bits to one, making explicit the implied 24 bit of the floating point input value. In block 326, the processor 102, up-shifts the 24 bit mantissa value by eight to move the mantissa bits into the upper 24 bits of a 32 bit value, thereby converting the Q23 mantissa value to a Q31 mantissa value, where a Q23 mantissa includes 23 bits of fractional data and a Q31 mantissa includes 31 bits of fractional data. The Q31 mantissa may be stored as a 32 bit unsigned integer.

In block 328, the processor 102 extracts the eight bit exponent from the floating point input value, and normalizes the exponent by subtracting 127 in block 330. The exponent may be stored as a 16 bit signed integer. Thus, the processor 102 separates the floating point input value into sign, mantissa, and exponent values to convert the floating point value to a fixed point value.

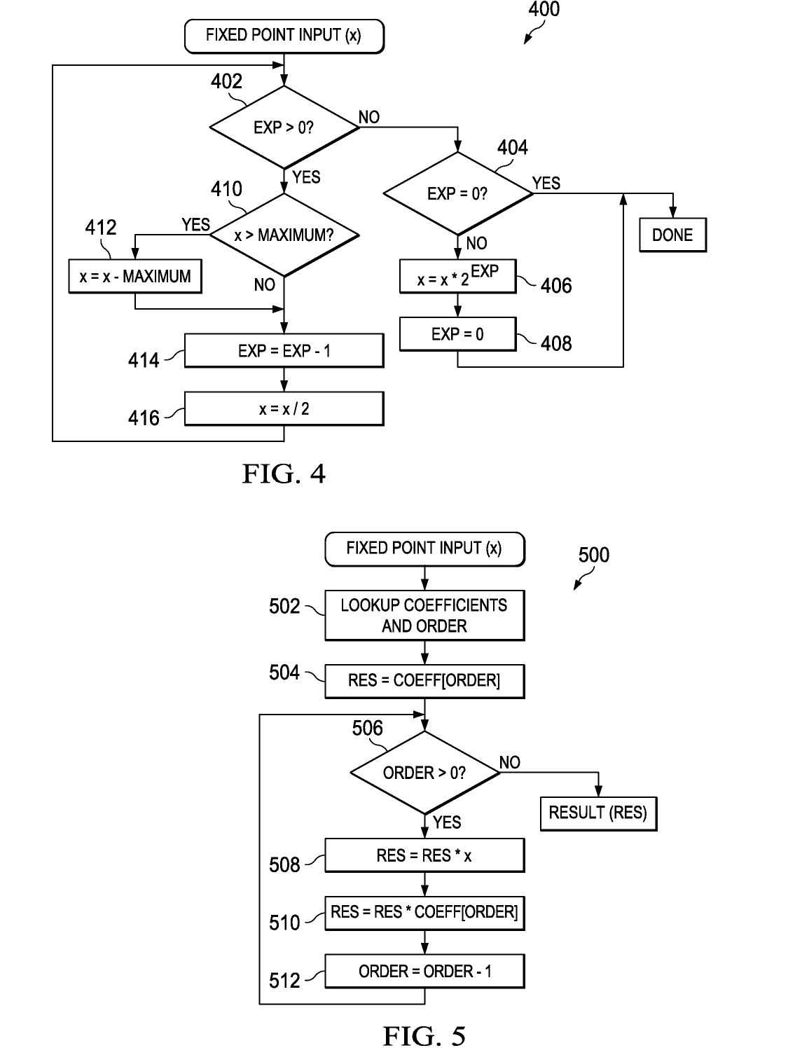

FIG. 4 shows a flow diagram for a method 400 for reducing the range of a fixed point operand in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 400, as well as other operations described herein, can be performed by a processor executing instructions stored in a computer readable medium as disclosed herein. Operations of the method 400 may be performed to adjust the range of the fixed point value produced in the conversion of method 300 as part of block 216 of the method 200. The range reduction of method 400 is useful for trigonometric functions where any multiple of 27 can be subtracted and produce the same result.

In block 402, the processor 102 determines whether the normalized exponent is greater than zero. If the normalized exponent is not greater than zero, then in block 404, the processor 102 determines whether the value of the normalized exponent is zero. If the value of the normalized exponent is zero, then no adjustment is performed. If the value of the normalized exponent is not zero, then the mantissa value is multiplied by two raised to the value of the exponent in block 406, and the exponent value is set to zero in block 408.

If the exponent is determined to be greater than zero in block 402, then the processor 102 adjusts the mantissa and exponent values to produce an exponent that is not greater than zero. In block 410, the processor 102 determines whether the mantissa value is greater than a predetermined maximum value. If the mantissa value is not greater than the maximum value, then the exponent is decremented in block 414 and the mantissa value halved in block 416 until the exponent is not greater than zero.

If the mantissa value is greater than the maximum value, then in block 412 the processor 102 subtracts the maximum value from the mantissa, and the exponent and mantissa are iteratively adjusted in blocks 414 and 416 until the exponent is not greater than zero. Thus, the method 400 produces a zero exponent value, and a mantissa value not greater than the predetermined maximum value.

FIG. 5 shows a flow diagram for a method 500 for evaluating a polynomial in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 500, as well as other operations described herein, can be performed by a processor executing instructions stored in a computer readable medium as disclosed herein. Operations of the method 500 may be performed to provide polynomial evaluation as part of blocks 212 and 218 of method 200.

In block 502, the processor 102 determines the order and coefficients of the polynomial to be applied to evaluate the function at the fixed point input value. In some embodiments, the coefficients and order information may be stored in a table or other structure in the storage 108.

In block 504, the processor 102 sets a result value to the highest order coefficient value. Thereafter, the processor 102 iteratively multiplies the fixed point input value by the current result value in block 508, adds the coefficient value to the result in block 510, and decrements the polynomial order index in block 512 until an order index value is zero.

Thus, the method 500 evaluates the polynomial:

res=c₀x⁰+c₁x¹+c₂x²+c₃x³ . . .

where c is a coefficient value, and x is the fixed point input value.

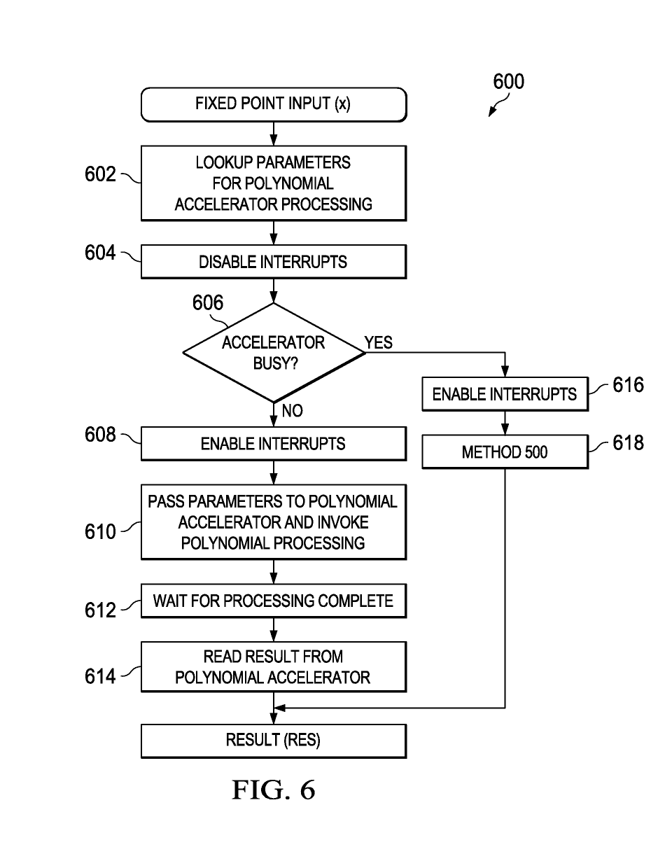

FIG. 6 shows a flow diagram for a method 600 for evaluating a polynomial using a polynomial accelerator in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be performed by a processor executing instructions stored in a computer readable medium as disclosed herein. Operations of the method 600 may be performed to provide polynomial evaluation as part of blocks 212 and 218 of method 200.

In block 602, the processor 102 looks up the parameters to be applied by the polynomial accelerator 106 for approximation of the function being evaluated. The parameters may include, for example, the order and coefficients of the polynomial.

In block 604, the processor 102 may disable interrupts. Disabling interrupts may avoid conflicts associated with the selection and use of the polynomial accelerator 106.

In block 606, the processor 102 determines whether the polynomial accelerator 106 is currently busy. If the polynomial accelerator 106 is busy, then the processor 102 may enable interrupts in block 616 and apply the method 500 to generate a solution to the polynomial in block 618.

If the processor 102 determines that the polynomial accelerator 106 is not busy, then, in block 608, the processor 102 may enable interrupts. The processor 102 may pass the polynomial parameters to the polynomial accelerator and invoke processing of the polynomial in block 610.

In block 612, the polynomial accelerator is processing the polynomial and other portions of the processor 100 (e.g., the central processing unit) wait for polynomial processing to complete. In some embodiments, the other portions of the processor 100 may enter a reduced power mode while awaiting completion of polynomial processing.

In block 614, processor 102 reads the result value from the polynomial accelerator 106.

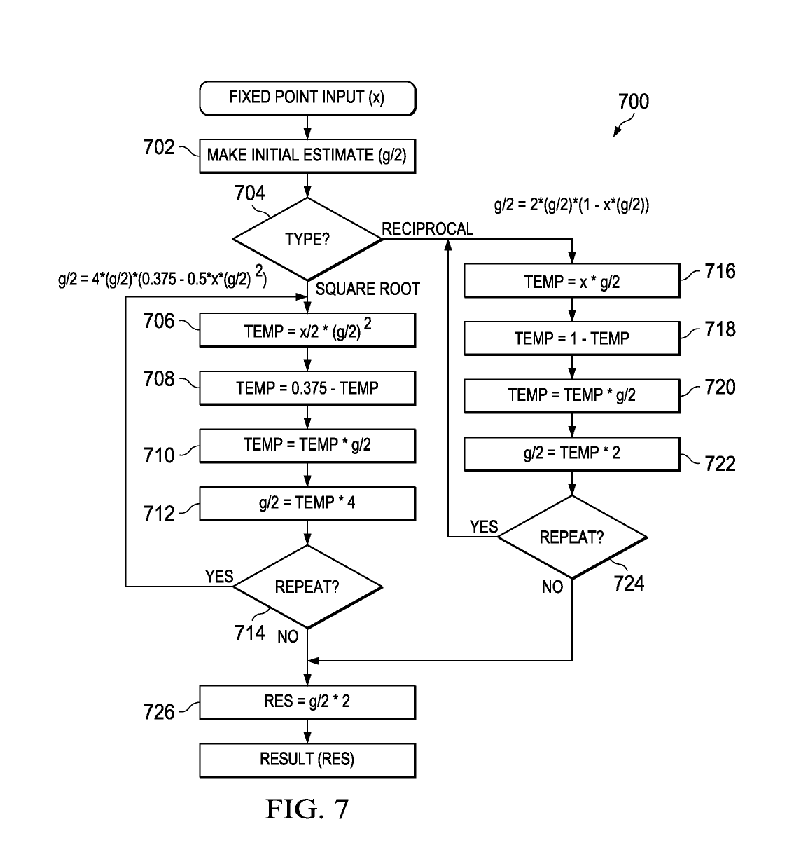

FIG. 7 shows a flow diagram for a method for evaluating a function using Newton-Raphson approximation in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 700, as well as other operations described herein, can be performed by a processor executing instructions stored in a computer readable medium as disclosed herein. Operations of the method 700 may be performed to provide Newton-Raphson approximation as part of block 210 of method 200.

In block 702, the processor 102 makes an initial estimate of value of the function at the fixed point input value. In some embodiments the initial estimate may be provided as one-half of the actual estimate to allow iteration without overflow.

In block 704, the processor 102 determines whether a reciprocal or square root function is selected for evaluation. If the function is a reciprocal function, the processor 102 iteratively executes the operations of blocks 716-724 to solve the equation:

$$\frac{g}{2} = 2 \frac{g}{2} ( 1 - \frac{xg}{2} )$$

Each iteration reduces the error in the result. Some embodiments may employ two iterations.

If, in block 704, the processor 102 determines that the function is a square root, then the processor 102 iteratively executes the operations of blocks 706-714 to solve the equation:

$$\frac{g}{2} = 4 \frac{g}{2} ( 0.375 - 0.5 {x ( \frac{g}{2} )}^{2} ) ,$$

where x is the fixed point input value. Each iteration reduces the error in the result. Some embodiments may employ two iterations.

When iterative processing is complete, the processor 102 doubles the result of iteration in block 726 to produce a final fixed point result value.

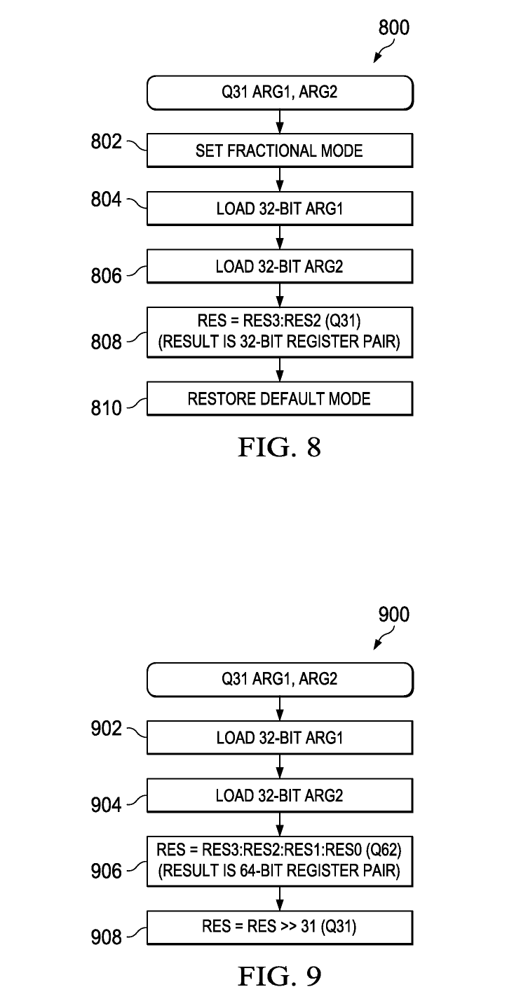

FIG. 8 shows a flow diagram for a method 800 for multiplying operands using a multiplier 104, where the multiplier 104 has a selectable fractional mode. Though depicted sequentially as a matter of convenience, at least some of the actions shown can be performed in a different order and/or performed in parallel. Additionally, some embodiments may perform only some of the actions shown. In some embodiments, at least some of the operations of the method 800, as well as other operations described herein, can be performed by a processor executing instructions stored in a computer readable medium as disclosed herein. Operations of the method 800 may be performed to provide multiplication operations in the polynomial and Newton-Raphson approximations of blocks 218 and 210, as well as other operations disclosed herein.

In block 802, the processor 102 sets the multiplier 104 to operate in fractional mode. In blocks 804 and 806 the processor 102 loads two 32-bit arguments to be multiplied. The arguments may be Q31 fractional data that includes a sign bit and 31 bits of fractional data. The arguments may, for example, be loaded into registers used by the multiplier 104.

In block 808, the multiplier 104 fractionally multiplies the operands producing a 32 bit (Q31) result. If the processor 102 is a 16-bit device, the result may be stored in a pair of 16-bit registers.

In block 810, the processor 102 may restore the multiplier 104 to a default operational mode (e.g., integer multiplication mode).

FIG. 9 shows a flow diagram for a method 900 for multiplying operands using a multiplier lacking a fractional mode. Though depicted sequentially as a matter of convenience, at least some of the actions shown can be performed in a different order and/or performed in parallel. Additionally, some embodiments may perform only some of the actions shown. In some embodiments, at least some of the operations of the method 900, as well as other operations described herein, can be performed by a processor executing instructions stored in a computer readable medium as disclosed herein. Operations of the method 900 may be performed to provide multiplication operations in the polynomial and Newton-Raphson approximations of blocks 218 and 210, as well as other operations disclosed herein.

In blocks 902 and 904 the processor 102 loads two 32-bit arguments to be multiplied. The arguments may be Q31 fractional data. The arguments may, for example, be loaded into registers used by the multiplier.

In block 906, the multiplier multiplies the operands producing a 64 bit result. If the processor 102 is a 16-bit device, the result is stored in across 4 registers.

In block 908, the processor 102 downshifts the 64 bit result by 31 bits to produce a 32 bit Q31 fractional result. The 64 bit operations of blocks 906 and 908 can be computationally expensive and add substantial time the evaluation of a function when compared to the multiplication of method 800.

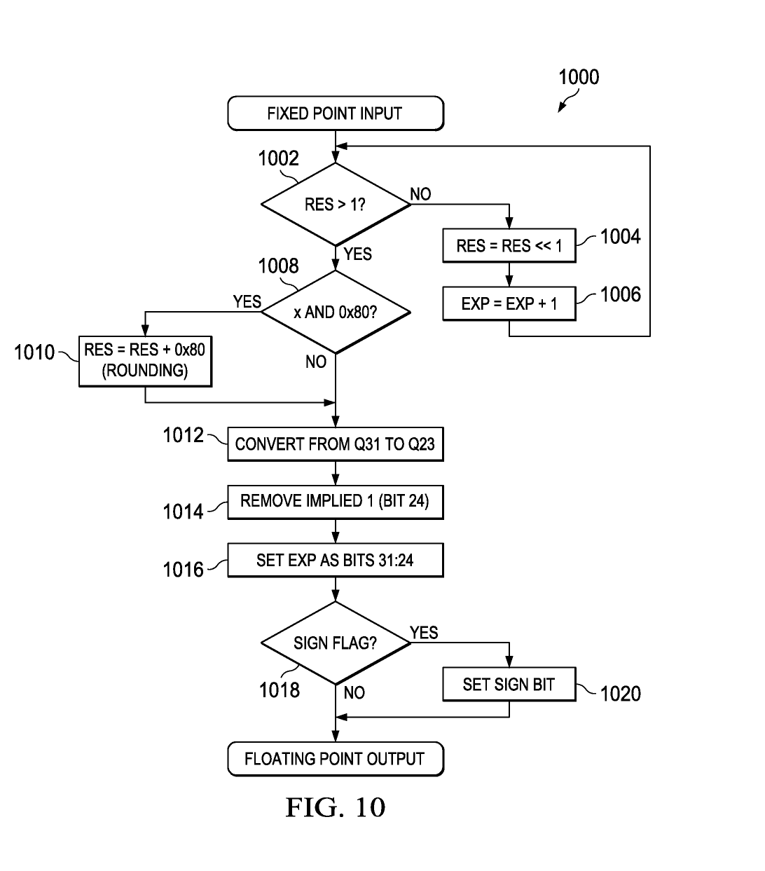

FIG. 10 shows a flow diagram for a method 1000 for converting a fixed point result of function evaluation to a floating point format in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 1000, as well as other operations described herein, can be performed by a processor executing instructions stored in a computer readable medium as disclosed herein. Operations of the method 1000 may be performed to provide fixed point to floating point conversion as part of block 220 of method 200.

In block 1002, the processor determines whether the mantissa value of the fixed point result is greater than one. If the mantissa value is not greater than one, then, in blocks 1004 and 1006, the mantissa value is shifted up, and the exponent correspondingly decremented, until the mantissa value is greater than one.

If the mantissa value is greater than one, then in block 1008, the processor 102 examines the most significant bit of the fixed point mantissa to be dropped from the floating point mantissa, and rounds the fixed point mantissa value up in block 1010 if the bit is set.

In block 1012, the processor 102 converts the Q31 mantissa to a Q23 mantissa (23 bits of fractional data), and in block 1014 removes the implied one value as per IEEE 754 floating point.

In block 1016, the eight exponent bits are inserted above the 23 bit fractional mantissa in the floating point result value.

In blocks 1018, the processor 102 checks the sign flag of the fixed point result, and if set, sets the sign bit of the floating point result value in block 1020.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A method, comprising:
receiving, by a processor, a value to be processed, the value represented in a floating point format;
receiving, by the processor, notification of a function to be applied to the value;
converting, by the processor, the value to a fixed point format;
determining, by the processor, which of Newton-Raphson and polynomial approximation is to be used to apply the function to the value in the fixed point format;
applying, by the processor, the function to the value in the fixed point format to generate a result in the fixed point format; and
converting, by the processor, the result to the floating point format.

2. The method of claim 1, wherein the converting to the fixed point format comprises:
separating the value in the floating point format into an exponent value, a mantissa value, and a sign value;
subtracting 127 from the exponent value; and
shifting the mantissa value up by eight bits.

3. The method of claim 1, further comprising:
reducing the range of the value in the fixed point format by:
reducing the exponent value to zero; and
adjusting the mantissa value in accordance with the exponent reduction.

4. The method of claim 1, further comprising:
determining an order of a polynomial to apply;
determining coefficients of the polynomial;
determining whether the processor comprises an available polynomial acceleration unit; and
based on a determination that the processor lacks an available polynomial acceleration unit Iteratively applying the coefficients to the value in the fixed point format.

5. The method of claim 1, further comprising:
determining whether the processor comprises a polynomial acceleration unit;
determining an order of a polynomial to apply;
determining coefficients of the polynomial; and
based on a determination that the processor comprises an available polynomial acceleration unit:
passing the coefficient, order, and value in the fixed point format to the polynomial acceleration unit; and
computing a result of the polynomial in the polynomial acceleration unit.

6. The method of claim 1, further comprising:
determining that Newton-Raphson approximation should be applied based on the function being one of a reciprocal and a square root;
determining an initial approximation of the result in the fixed point format;
iteratively adjusting and reducing error in the result in the fixed point format via Newton-Raphson approximation.

7. The method of claim 1, further comprising:
setting a multiplier of the processor to fractional mode;
applying the multiplier in fractional mode to compute the result via polynomial or Newton-Raphson approximation.

8. The method of claim 1, further comprising:
converting the result in the fixed point format to the floating point format by:
adjusting mantissa and exponent of the result in the fixed point format until the mantissa is greater than one;
combining the mantissa, the exponent, and sign bit of the result in the fixed point format to produce the floating point result.

9. A non-transitory computer-readable medium encoded with instructions that when executed cause a processor to:
receive a value to be processed, the value in a floating point format;
receive notification of a function to be applied to the value;
convert the value to a fixed point format;
determine which of Newton-Raphson and polynomial approximation is to be used to apply the function to the value in the fixed point format;
apply the function to the value in the fixed point format to generate a result in the fixed point format; and
convert the result to the floating point format.

10. The computer-readable medium of claim 9, encoded with instructions that when executed cause a processor to:
separate the value in a floating point format into an exponent value, a mantissa value, and a sign value;
subtract 127 from the exponent value; and
shift the mantissa value up by eight bits.

11. The computer-readable medium of claim 9, encoded with instructions that when executed cause a processor to:
reduce the range of the value in the fixed point format by:
reducing the exponent value to zero; and
adjusting the mantissa value in accordance with the exponent reduction.

12. The computer-readable medium of claim 9, encoded with instructions that when executed cause a processor to:
determine an order of polynomial to apply;
determine coefficients of the polynomial;
determine whether the processor comprises an available polynomial acceleration unit; and
based on a determination that the processor lacks an available polynomial acceleration unit, Iteratively apply the coefficients to the value in the fixed point format;
based on a determination that the processor comprises an available polynomial acceleration unit:
pass the coefficient, order, and value in the fixed point format to the polynomial acceleration unit; and
compute a result of the polynomial in the polynomial acceleration unit.

13. The computer-readable medium of claim 9, encoded with instructions that when executed cause a processor to:
set a multiplier of the processor to fractional mode;
apply the multiplier in fractional mode to compute the result in the fixed point format via polynomial or Newton-Raphson approximation.

14. The computer-readable medium of claim 9, encoded with instructions that when executed cause a processor to:
convert the result to the floating point format by:
adjusting mantissa and exponent of the result in the fixed point format until the mantissa is greater than one;
combining the mantissa, the exponent, and sign bit of the result in the fixed point format to produce the floating point result.

15. A system, comprising:
a processor comprising a multiplier that is selectably configurable to operate in a fractional mode; and
mathematical processing logic that when executed causes the processor to:
receive a floating point value to be processed;
receive notification of a function to be applied to the floating point value;
convert the floating point value to a fixed point value;
determine which of Newton-Raphson and polynomial approximation is to be used to apply the function to the fixed point value;
apply the function to the fixed point value to generate a fixed point result; and
convert the fixed point result to a floating point result.

16. The system of claim 15, wherein the processor further comprises a polynomial accelerator; and the mathematical processing logic, when executed, causes the processor to:
determine an order of polynomial to apply;
determine coefficients of the polynomial;
determine whether the polynomial accelerator is available; and
based on a determination that the polynomial accelerator is available:
pass the coefficient, order, and fixed point value to the polynomial accelerator; and
evaluate the polynomial with respect to the fixed point value in the polynomial accelerator.

17. The system of claim 15, wherein the mathematical processing logic, when executed, causes the processor to:
determine an order of polynomial to apply;
determine coefficients of the polynomial; and
evaluate the polynomial by iteratively applying the coefficients to the value in the fixed point format.

18. The system of claim 15, wherein the mathematical processing logic, when executed, causes the processor to:
set the multiplier to operate in the fractional mode;
apply the multiplier in the fractional mode to compute the fixed point result via polynomial or Newton-Raphson approximation.

19. The system of claim 15, wherein the mathematical processing logic, when executed, causes the processor to:
convert the fixed point result to the floating point result by:
adjusting mantissa and exponent of the fixed point result until the mantissa is greater than one;
combining the mantissa, the exponent, and sign bit of the adjusted fixed point result to produce the floating point result.

20. The system of claim 15, wherein the mathematical processing logic, when executed, causes the processor to:
convert the floating point value to the fixed point value by:
separating the floating point value into an exponent value, a mantissa value, and a sign value;
subtracting 127 from the exponent value; and
shifting the mantissa value up by eight bits; and
reduce the range of the fixed point value by:
reducing the exponent value to zero; and
adjusting the mantissa value in accordance with the exponent reduction.
